(19) United States
(12) Patent Application Publication
(10) Pub. No.: US 2003/0127275 A1
(43) Pub. Date: Jul. 10, 2003

(54) High efficiency automotive hydraulic power steering system

(76) Inventors: Clayton R. Rogers, Springfield, MO (US); Billy L. Speer, Springfield, MO (US); Joey D. Edson, Seymour, MO (US); Richard J. Meckstroth, Vonore, TN (US)

Correspondence Address: DAYCO PRODUCTS, LLC, 1 PRESTIGE PLACE, MIAMISBURG, OH, 45342, US

(21) Appl. No.: 10/044,181

(22) Filed: Jan. 10, 2002

(51) Int. Cl. B62D 5/06

(52) U.S. Cl. 180/417; 180/442

(57) ABSTRACT

A hydraulic power steering system for use in a vehicle to eliminate energy waste when power assist is not required is disclosed. The hydraulic power steering system includes a pulley powered by a crankshaft in the vehicle, a clutch operably connected to the pulley, a hydraulic pump operably connected to the clutch, and controlling means for engaging and disengaging the clutch with the pulley and the hydraulic pump to provide hydraulic power to the system. It also includes a hydraulic accumulator to provide system pressure for short periods before the pump clutch can engage in response to a steering input.

### BACKGROUND OF THE INVENTION

The present invention relates to automotive hydraulic power steering systems, and more specifically to a power steering system which prevents wasted energy when no power assist is required, reduces load on the motor starter and eliminates the need for noise-reducing components.

Hydraulic power steering systems generally have become a standard feature throughout the automotive industry and are particularly advantageous in medium and larger sized automobiles. Typically, in a power steering system, the engine crankshaft drives the power steering pump through a belt and pulley arrangement.

Since most car and light truck steering gears are of the rack and pinion configuration, with a simple hydraulic piston that pushes the rack to the left or right, this configuration will be referred to in the following explanations.

The power steering pump includes a pressure hose and a return line, and a high pressure limiting pressure relief valve. Sometimes there is an electronically controlled bypass mechanism at the pump that reduces the volumetric efficiency of the pump as the pump RPM increases, since less pressure is required at higher vehicle and engine speeds.

During normal low power steering system demand conditions, the pump is in a high flow, low pressure mode, as the flow through the gear is mostly diverted away from filling either side of the steering gear, and the fluid is returned to the reservoir. It is this high flow condition, combined with a higher than necessary minimum system pressure, that represents a significant hydraulic power steering system parasitic loss. Established industry rationale for the high flow is that it results in a quicker response in an accident avoidance maneuver. Established industry rationale for the high minimum operating pressure is that it results in a more solid “center feel,” and gives better straight ahead vehicle stability.

Other less power consuming methods of achieving straight line stability of “strong center feel” are to add more suspension caster and less “scrub radius”. As less scrub radius exists, the natural vehicle aligning effect, due to suspension caster, can be achieved.

The hydraulic pressure at the power steering pump outlet increases as the power steering system hydraulic restriction increases. When the operator turns the steering wheel, the fluid flow is diverted from a steering gear bypass mode into a mode where it is filling one side of the rack cylinder or the other, depending on which way the steering wheel is turned. Depending on how hard the steering wheel is turned, the valve is opened proportionately more or less. This valve is a complex valve that both shuts the gear bypass passage, while opening a valve to fill one steering gear chamber or the other.

As the rack resists the right or left motion that is being requested by the steering wheel torque, more pressure is built up since the flow becomes restricted by the gear piston that is resisting motion. As more pressure builds, more force becomes available to move the piston and the rack. The limit of how much pressure is available is the pressure at pressure relief condition in the pump.

While this system assures that hydraulic pressure is always available when needed, a significant amount of energy is wasted when no power assist is required, i.e., in an idling parked vehicle, where the hydraulic pump unnecessarily continues to consume non-productive energy. Therefore, it is an object of the present invention to provide a solution for eliminating the consumption of non-productive energy in power steering systems.

### SUMMARY OF THE INVENTION

In accordance with the present invention, a clutch which is controlled by a controlling means such as a hysteresis pressure switch or a microprocessor in the high pressure side of the hydraulic circuit, is introduced between the pulley and the hydraulic pump. To assure that hydraulic power is available when the clutch is disengaged, a hydraulic accumulator and check valves are utilized in the high pressure side of the hydraulic circuit. In addition, the rotary actuated control valve located in the hydraulic circuit, has a closed center design so that pressure is maintained in the hydraulic accumulator until needed. The hydraulic fluid capacity of the hydraulic reservoir is equal to the difference between the maximum amount (charged state) of hydraulic fluid and the minimum amount (discharged state) of hydraulic fluid in the accumulator.

Due to the inherent nature of hydraulic accumulators to dampen transients in the hydraulic system, the need for hydraulic noise-reducing components such as tuners and mufflers can be eliminated from the system. Also, a smaller capacity and/or different type of hydraulic pump, such as a variable displacement or gear-type hydraulic pump may be employed in the system.

### BRIEF DESCRIPTION OF THE DRAWINGS

FIG. 1 is a schematic diagram of a prior art power steering system;

FIG. 2 is a schematic diagram of one embodiment of the present invention; and

FIG. 3 is a schematic diagram of another embodiment of the present invention.

### DETAILED DESCRIPTION OF THE INVENTION

The present invention relates to a power steering system which eliminates wasted energy when power-assist is not necessary, such as when a vehicle is idling and not engaged in actual driving and steering situations.

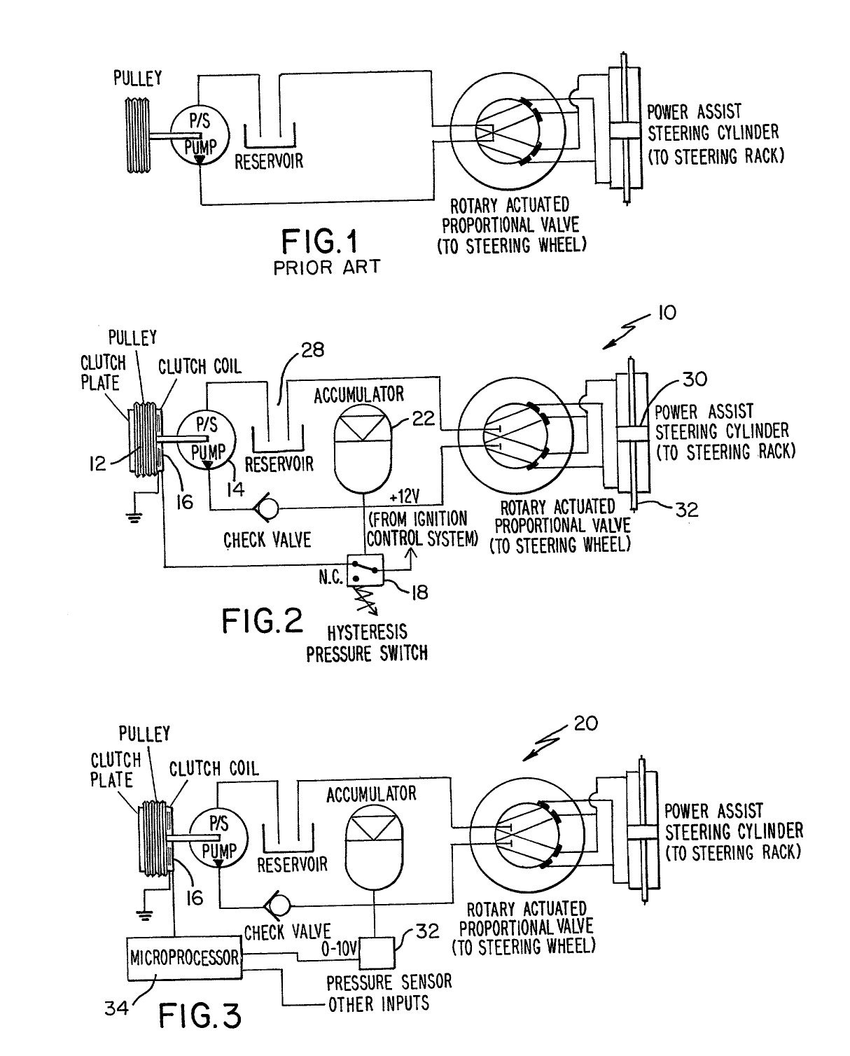

With respect to the drawings, FIG. 1 illustrates a prior art power steering system which utilizes a belt-driven hydraulic pump that operates and produces fluid flow whenever the vehicle engine is running. Such system utilizes hydraulic power even when power assist in not necessary causing the hydraulic pump to continuously consume non-productive energy.

FIG. 2 illustrates one embodiment of the invention where the power steering system 10 comprises a pulley 12, a hydraulic pump 14 which is driven by a belt (not shown) off of the pulley 12, and a clutch coil 16 positioned between the pulley 12 and the hydraulic pump 14. The clutch coil 16 is controlled by a controlling means, e.g., a hysteresis pressure switch 18 in the high pressure side of the hydraulic circuit. To insure that hydraulic power is available when the clutch coil 16 is engaged, a hydraulic accumulator 22 operably connected to the hysteresis pressure switch and a check valve 24 operably connected to the hydraulic pump are utilized in the high pressure side of the hydraulic circuit. A rotary actuated proportional control valve 26 utilizes a closed center design (blocked in the center position) so that fluid pressure is maintained in the hydraulic accumulator 22 until needed.

The power steering system of the invention further includes a reservoir 28 operably connected to the rotary actuated proportional control valve 26 for retaining hydraulic fluid. The hydraulic fluid capacity of the reservoir 28 is equal to the difference between the maximum amount (charged state) of hydraulic fluid and the minimum amount (discharged state) of hydraulic fluid in the accumulator 22. A power assist steering cylinder 30 is operably connected to said rotary actuated proportional valve 26 and to a steering rack 32 to provide power assist steering for the vehicle.

The electrical power source to the hysteresis pressure switch 18 is supplied by the vehicle ignition control system so that power is not supplied when the engine is not running or being started. This not only insures that the clutch is not engaged when the engine is not running causing a drain on the battery but also reduces the load on the motor starter since the hydraulic pump 16 would not be engaged during starting. The hysteresis pressure switch 18 is designed and wired to engage the clutch coil 16 when the pressure in the hydraulic accumulator 22 is reduced to a level such that under the worst conditions, e.g., where the engine is at idle with maximum steering demand, the system pressure never goes below the absolute minimum required, taking into account clutch engagement and pump response delay time. The hysteresis pressure clutch 18 is further designed and wired to disengage the clutch coil 16 when the pressure in the hydraulic accumulator 22 has reached its maximum allowable pressure.

In accordance with the present invention, the hydraulic accumulator 22 provides the maximum amount of stored hydraulic energy at a sufficiently high pressure under the worst conditions given required space, weight, life reliability and cost restraints. To further reduce the total system space required and reduce the part's count, the hysteresis pressure switch 18 may be integrated into the hydraulic accumulator 22. Also, a smaller capacity and/or different type of hydraulic pump, such as a variable displacement or gear-type pump may be employed in the power steering system of the present invention.

Due to the inherent nature of the hydraulic accumulator 22, acting as low-pass filters, to dampen transients in the hydraulic system, the need for hydraulic noise reducing components such as tuners and mufflers may be eliminated.

FIG. 3 illustrates another embodiment of the invention where the power steering system 20 utilizes a microprocessor 34 to control the clutch coil 12. In accordance with the second embodiment, the hysteresis pressure switch 18 (FIG. 2) is replaced with a pressure sensor 32 and used as an input to the microprocessor 34 along with other inputs such as steering wheel rotation, vehicle speed, etc.

While particular embodiments of the invention have been shown and described, numerous variations and alternate embodiments will occur to those skilled in the art. Accordingly, it is intended that the present invention be limited only in terms of the appended claims.

What is claimed is:

1. A hydraulic power steering system for use in a vehicle to eliminate energy waste when power assist is not required comprising:
a pulley powered by a crankshaft in said vehicle;
a clutch operably connected to said pulley;
a hydraulic pump operably connected to said clutch; and
controlling means for engaging and disengaging said clutch with said pulley and said hydraulic pump to provide hydraulic power to said system.

2. The hydraulic steering system of claim 1 wherein said steering means is a power assisted steering system.

3. The system of claim 1 wherein said controlling means is a hysteresis pressure switch.

4. The system of claim 3 further comprising an electrical power source operably connected to said hysteresis pressure switch.

5. The system of claim 4 wherein said electrical power source is a vehicle ignition control system.

6. The system of claim 1 wherein said controlling means is a microprocessor.

7. The system of claim 6 wherein said microprocessor receives input from at least one of a pressure sensor, steering wheel rotation sensor and vehicle speed sensor.

8. The system of claim 3 further including a hydraulic accumulator operably connected to said hysteresis pressure switch to insure that hydraulic power is available when said clutch is disengaged.

9. The system of claim 1 further including a check valve operably connected to said hydraulic pump to maintain hydraulic pressure in said hydraulic accumulator when said clutch is disengaged.

10. The system of claim 7 further including a reservoir containing hydraulic fluid wherein said reservoir is operably connected to said power steering pump.

11. The system of claim 8 further including a rotary actuated control valve operably connected to said reservoir and to said check valve.

12. The system of claim 9 wherein said rotary actuated control valve is provided with a closed center to maintain pressure in said hydraulic accumulator until needed.

13. The system of claim 9 further including a power assist steering cylinder operably connected to said rotary actuated proportional valve and to a steering rack to provide power assist steering for said vehicle.

14. The system of claim 8 wherein said hydraulic accumulator dampens transients in the hydraulic system such that the need for hydraulic noise reducing components are not required.

15. A hydraulic power steering system for use in a vehicle to eliminate energy waste when power assist is not required comprising:
a pulley powered by a crankshaft in said vehicle;
a clutch operably connected to said pulley;
a hydraulic pump operably connected to said clutch;
a hysteresis pressure sensor for engaging and disengaging said clutch with said pulley and said hydraulic pump to provide hydraulic power to said system.
a vehicle ignition power source;
a hydraulic accumulator operably connected to said hysteresis pressure switch to insure that hydraulic power is available when said clutch is disengaged;
a check valve operably connected to said hydraulic pump to maintain hydraulic pressure in said hydraulic accumulator when said clutch is disengaged;
a reservoir containing hydraulic fluid, said reservoir being operably connected to said power steering pump;
a rotary actuated control valve operably connected to said reservoir and to said check valve; and
a power assist steering cylinder operably connected to said rotary actuated proportional valve and to a steering rack to provide power assist steering to said vehicle.

16. The system of claim 15 wherein said rotary actuated control valve is provided with a closed center to maintain pressure in said hydraulic accumulator until needed.

17. The system of claim 15 wherein said reservoir has a hydraulic fluid capacity equal to the difference between the maximum charged amount of hydraulic fluid and the minimum discharged amount of hydraulic fluid in the hydraulic accumulator.

18. A hydraulic power steering system for use in a vehicle to eliminate energy waste when power assist is not required comprising:
a pulley powered by a crankshaft in said vehicle;
a clutch operably connected to said pulley;
a hydraulic pump operably connected to said clutch;
a microprocessor for engaging and disengaging said clutch with said pulley and said hydraulic pump to provide hydraulic power to said system wherein said microprocessor receives input from at least one of a pressure sensor, steering wheel rotation sensor and vehicle speed sensor;
a vehicle ignition power source;
a hydraulic accumulator operably connected to said hysteresis pressure switch to insure that hydraulic power is available when said clutch is disengaged;
a check valve operably connected to said hydraulic pump to maintain hydraulic pressure in said hydraulic accumulator when said clutch is disengaged;
a reservoir containing hydraulic fluid, said reservoir being operably connected to said power steering pump;
a rotary actuated control valve operably connected to said reservoir and to said check valve; and
a power assist steering cylinder operably connected to said rotary actuated proportional valve and to a steering rack to provide power assist steering to said vehicle.

19. The system of claim 18 wherein said rotary actuated control valve is provided with a closed center to maintain pressure in said hydraulic accumulator until needed.

20. The system of claim 18 wherein said reservoir has a hydraulic fluid capacity equal to the difference between the maximum charged amount of hydraulic fluid and the minimum discharged amount of hydraulic fluid in the hydraulic accumulator.
